(19) United States
(12) Patent Application Publication
(10) Pub. No.: US 2010/0110094 A1
(43) Pub. Date: May 6, 2010

(54) DISPLAY CONTROL DEVICE, DISPLAY DEVICE, AND DISPLAY CONTROL METHOD

(75) Inventors: Teruhiko Kamibayashi, Kobe (JP); Junji Hashimoto, Kobe (JP)

Correspondence Address: OLIFF & BERRIDGE, PLC, P.O. BOX 320850, ALEXANDRIA, VA, 22320-4850, US

(73) Assignee: Fujitsu Ten Limited, Kobe-shi (JP)

(21) Appl. No.: 12/450,064

(22) PCT Filed: Mar. 17, 2008
(86) PCT No.: PCT/JP2008/054852

§ 371 Date: Sep. 10, 2009

(30) Foreign Application Priority Data
Mar. 23, 2007 (JP) 2007-077539

(51) Int. Cl. G09G 5/02; G09G 5/00

(52) U.S. Cl. 345/589; 345/4

(57) ABSTRACT

A display control device includes: a differential circuit that detects a difference in luminance between a first image and a second image in units of pixels; a comparison circuit that detects whether or not the difference in luminance between the first image data and the second image data is equal to or greater than a first threshold value on the basis of the detected differential value in luminance; a controller that interpolates a pixel value, having a luminance smaller than an attention pixel of at least one of the first image and the second image, in said at least one of the first image and the second image, when a difference in luminance between an attention pixel of the first image and an attention pixel of the second image is equal to or greater than a first threshold value; and a liquid crystal panel driving unit 74 that displays the first image and the second image on a common display portion such that the first image and the second image are respectively visible from different viewing directions.

### TECHNICAL FIELD

The present invention relates to a display control device, a display device, and a display control method each having a so-called multi-view display function displaying different images to be respectively visible, from different viewing directions, on a common display screen.

### BACKGROUND ART

As a display control device with a so-called multi-view display having a common display screen, on which different images are respectively visible from different viewing directions, there has been known a multi-view display with a liquid crystal panel having a parallax barrier on the front side thereof. Different information (images) can be displayed on the right and left sides of the display screen by separating directions of lights through a backlight on a pixel basis (for example, as disclosed in Patent Document 1). Such a display control device is mounted on a vehicle, allowing the front-seat passenger to watch a TV program or another image, while the driver is checking a navigation map image.

[8 Patent Document 1] Japanese Unexamined Patent Publication No. 2005-78080

### DISCLOSURE OF THE INVENTION

### Problems to be Solved by the Invention

In the above-mentioned display control device, a so-called crosstalk occurs such that the both of right and left images are mixed according to a direction from which the display screen is watched. For example, while the driver is watching the navigation image, when the TV image of the front passenger's seat side leaks out to the driver's seat side and overlaps with the navigation image, there is a possibility that the driver cannot distinguish navigation information clearly.

The present invention has been made in view of the above described problems, and it is an object of the present invention to provide a display control device, a display device, and a display control method which can reduce crosstalk of images and improve the visibility of images.

### Means for Solving the Problems

The above object is achieved by a display control device characterized by including: comparison means that compares a luminance of a first image with a luminance of a second image in units of pixel; interpolation means that interpolates a pixel value, having a luminance smaller than an attention pixel of at least one of the first image and the second image, to said at least one of the first image and the second image, when a difference in luminance between an attention pixel of the first image and an attention pixel of the second image is equal to or greater than a first threshold value; and display control means that displays the first image and the second image on a common display portion such that the first image and the second image are respectively visible from different viewing directions.

The present invention reduces the difference in luminance between the first image and the second image. This reduces the crosstalk of images and improves the visibility of the images.

In the above configuration, the interpolation means may directly output pixel values of attention pixels of the first image data and the second image data to the display control means, when the difference in luminance between the attention pixel of the first image and the attention pixel of the second image is smaller than the first threshold value.

Therefore, only the luminance of the pixel having a large difference in luminance is reduced, thereby reducing the crosstalk.

A display control device according to the present invention includes: comparison means that compares a luminance of a first image with a luminance of a second image on a pixel basis; interpolation means that interpolates a black pixel in at least one of the first image and the second image, when a difference in luminance between an attention pixel of the first image and an attention pixel of the second image is equal to or greater than a second threshold value, and that interpolates a pixel value, having a luminance smaller than the attention pixel of at least one of the first image and the second image, in said at least one of the first image and the second image, when the difference in luminance between the attention pixel of the first image and the attention pixel of the second image is equal to or greater than a third threshold value, the third threshold value being smaller than the second threshold value; and display control means that displays the first image and the second image on a common display portion such that the first image and the second image are respectively visible from different viewing directions.

The present invention reduces the difference in luminance between the first image and the second image. This reduces the crosstalk of images and improves the visibility of the images.

A display control device according to the present invention includes: comparison means that compares a luminance of a first image with a luminance of a second image in units of pixel; interpolation means that interpolates a pixel value that is adjusted based on a difference in luminance between an attention pixel of the first image and an attention pixel of the second image in at least one of the first image and the second image; and display control means that displays the first image and the second image on a common display portion such that the first image and the second image are respectively visible from different viewing directions.

The present invention reduces the difference in luminance between the first image and the second image. This reduces the crosstalk of images and improves the visibility of the images.

In the above configuration, the comparison means may compare the luminance of the first image with the luminance of the second image by comparing a luminance of an RGB signal of the first image with a luminance of an RGB signal of the second image.

This compares the luminance of the first image with that of the second image with accuracy.

In the above configuration, the interpolation means may interpolate the pixel value having the luminance smaller than the attention pixel in the first image data and the second image data for every given frames.

This simplifies a process.

A display control device according to the present invention includes: comparison means that compares a luminance of a first image with a luminance of a second image for every block with a given size; interpolation means that interpolates a block of an image, having a luminance smaller than a block to be compared with, of at least one of the first image and the second image, in said at least one of the first image and the second image, when a difference in luminance between a block of the first image and a block of the second image is a first threshold value; and display control means that displays the first image and the second image on a common display portion such that the first image and the second image are respectively visible from different viewing directions.

The present invention reduces the difference in luminance between the first image and the second image. This reduces the crosstalk of images and improves the visibility of the images. Additionally, the control is performed in units of a given block, thereby simplifying a process.

In the above configuration, the comparison means may compare the luminance by determining an average value or a maximum value of each luminance of blocks, to be compared with, of the first image and the second image.

This compares the luminance of the first image with that of the second image within a block with accuracy.

In the above configuration, the interpolation means may interpolate the block of the image having the luminance having a smaller than the luminance of the block to be compared with for every given frames of each of the first image and the second image.

This simplifies the process.

A display device according to the present invention includes: a display that displays a first image and a second image on a common display portion such that the first image and the second image are respectively visible from different viewing directions; and the display control device according to any one of claims 1 to 9.

A display control method according to the present invention includes: a step that compares a luminance of a first image with a luminance of a second image in units of pixel; a step that that interpolates a pixel value, having a luminance smaller than an attention pixel of at least one of the first image and the second image, in said at least one of the first image and the second image, when a difference in luminance between an attention pixel of the first image and an attention pixel of the second image is equal to or greater than a first threshold value; and a step that displays the first image and the second image on a common display portion such that the first image and the second image are respectively visible from different viewing directions.

### Effects of the Invention

The present invention reduces the crosstalk of the images and improves the visibility of the images.

### BRIEF DESCRIPTION OF THE DRAWINGS

FIG. 1 is a view illustrating a basic configuration of a display device in accordance with an embodiment of the present invention;

FIG. 2 is a perspective view illustrating an example in which the display device is applied to a vehicle;

FIG. 3 is a functional block diagram illustrating a configuration of the display device;

FIG. 4 is a functional block diagram illustrating a configuration of a controller;

FIG. 5 is a functional block diagram illustrating a configuration of first and second image quality adjusting circuits;

FIG. 6 is a view illustrating a cross-sectional configuration of a display 100;

FIG. 7 is a front view of a liquid crystal panel;

FIG. 8 is a circuit diagram of a TFT substrate;

FIG. 9 is a functional block diagram illustrating a configuration of an image outputting portion;

FIG. 10 is a view illustrating a first circuit configuration determining whether or not a luminance of an attention pixel of a first image data is similar to that of an attention pixel of a second image;

FIG. 11 is a flowchart illustrating a process sequence of the controller;

FIG. 12 is an explanatory view of a method for comparing the first image data and the second image data in units of pixel;

FIG. 13 is a view illustrating the state where an interpolation pixel is interpolated alternately in a passenger's seat side image and a driver's side image;

FIG. 14 is a view illustrating a second circuit configuration determining whether or not the luminance of the attention pixel of the first image data is similar to that of the attention pixel of the second image;

FIG. 15 is a flowchart illustrating a process sequence of the controller;

FIG. 16 is a view illustrating a third circuit configuration determining whether or not the luminance of the attention pixel of the first image data is similar to that of the attention pixel of the second image;

FIG. 17 is a flowchart illustrating a process sequence of the controller;

FIG. 18 is a view illustrating a fourth circuit configuration determining whether or not the luminance of the attention pixel of the first image data is similar to that of the attention pixel of the second image;

FIG. 19 is an explanatory view of a method for comparing the first image data and the second image data in units of pixel;

FIGS. 20A and 20B are explanatory views of a method for comparing the first image data and the second image data in units of pixel;

FIG. 21 is a view illustrating one flame of image data is divided in units of block each being composed of N dot ′ M line, and explaining a method for controlling an interpolation of an interpolation image in units of block; and

FIG. 22 is an explanatory view of a method for interpolating the interpolation image for every given frames.

### BEST MODES FOR CARRYING OUT THE INVENTION

A description will be given of preferred embodiments with reference to the accompanying drawings.

### First Embodiment

In the following, a description will be given of preferred embodiments with reference to the accompanying drawings.

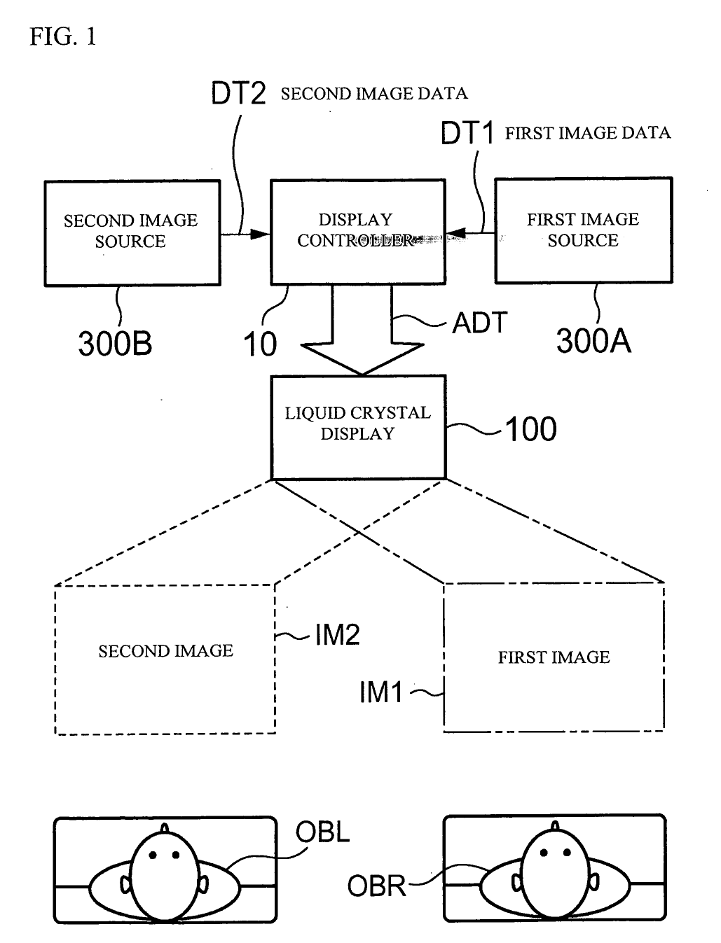

FIG. 1 is a view illustrating a basic configuration of a multi-view display device in accordance with an embodiment of the present invention.

Referring now to FIG. 1, the multi-view display apparatus includes a display controller 10 that serves as a display control device and a display 100 that serves as a display portion.

To the display controller 10, image data (image signal) DT1 is supplied from a first image source 300A, and image data (image signal) DT2 is also supplied from a second image source 300B. Then, the display controller 10 inputs these image data and outputs image data (image signal) ADT, which is composed of the first image data DT1 and the second image data DT2, to the common display 100. The configuration of the display controller 10 will be described later in detail.

The first image source 300A and the second image source 300B are respectively composed of a camera, a TV receiver, a DVD reproducing portion, a HD reproducing portion, a navigation portion, and the like, as will be described later.

The display 100 has a liquid crystal panel, a backlight, a parallax barrier, and the like (as will be described later in detail). The display 100 displays the first image IM1 based on the first image data to be visible by an observer OBR from the right side. Also, the display 100 displays the second image IM2 based on the second image data to be visible by an observer OBL from the left side. The first image data DT1 and the second image data DT2 are displayed on the common display. The configuration of the display 100 will also be described later in detail.

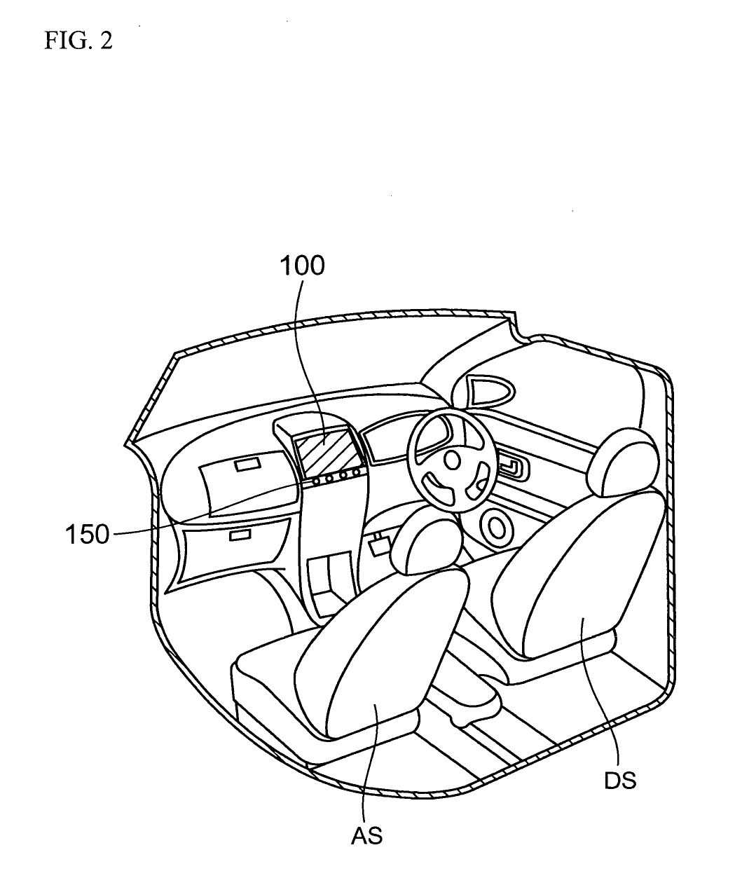

FIG. 2 is a perspective view illustrating an example in which the display controller 10 and the display 100 are applied to a vehicle.

Referring to FIG. 2, the display 100 is arranged between a driver's seat DS and a front passenger's seat AS in a dashboard area of the vehicle. In addition, the display 100 is provided with an operating portion 150 so as to manually operate the display controller 10.

According to an exemplary embodiment shown in FIG. 2, a passenger who sits on the driver's seat DS corresponds to the above-described observer OBR, and another passenger who sits on the front passenger's seat AS corresponds to the above-described observer OBL. Those passengers are able to simultaneously watch the first image IM1 and the second image IM2, which are respectively different, and which are bing displayed on the screen on the display 100 from the driver's seat DS and from the front passenger's seat AS.

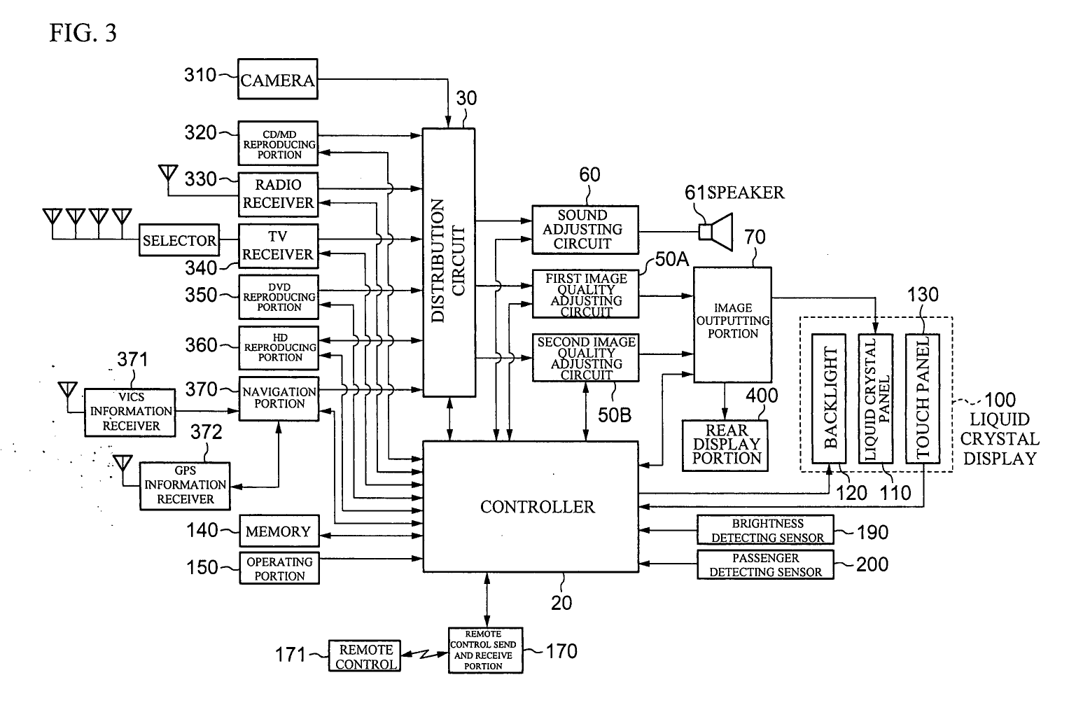

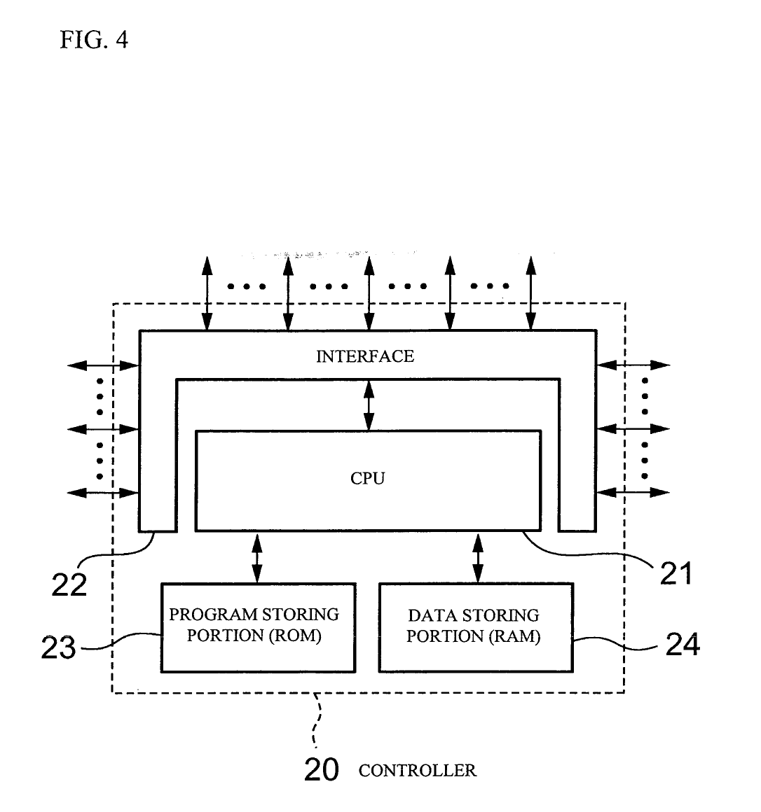

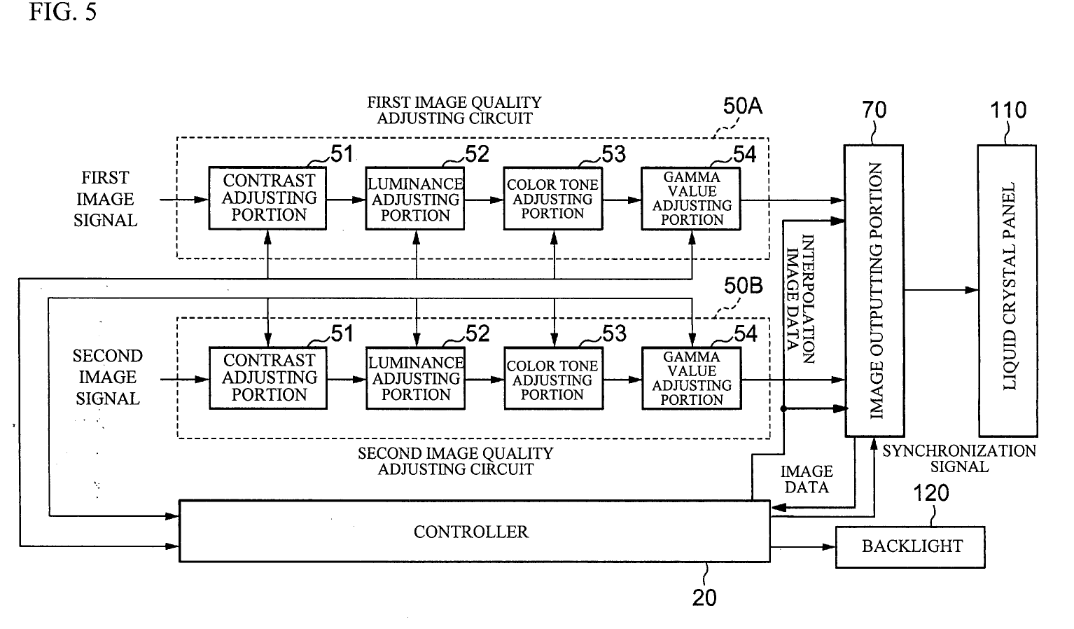

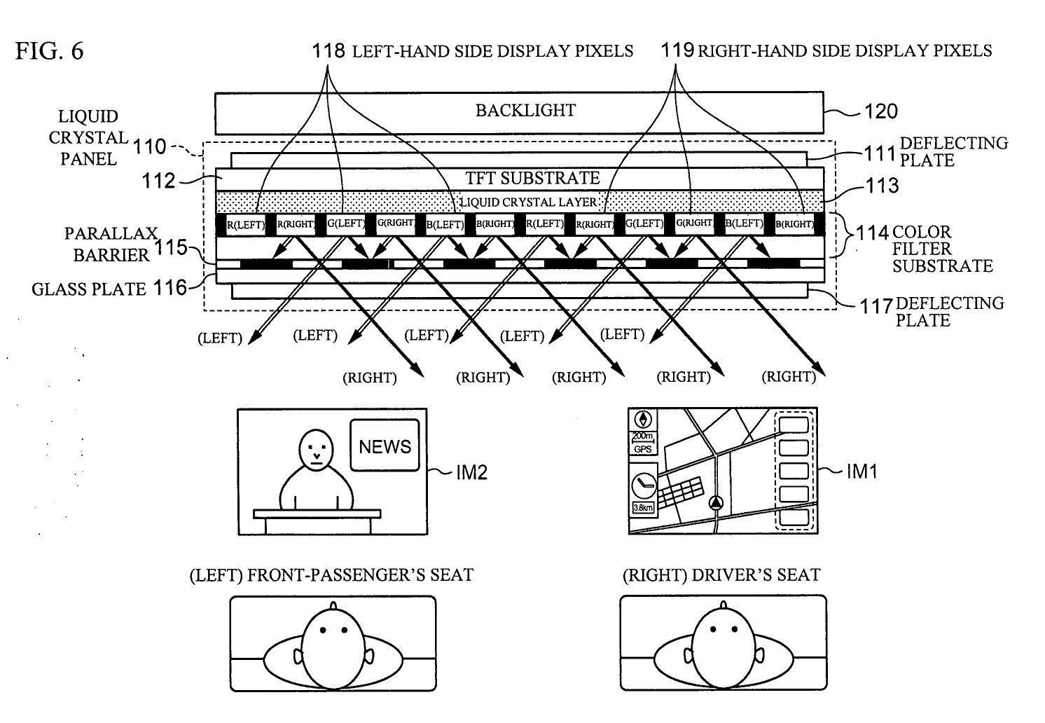

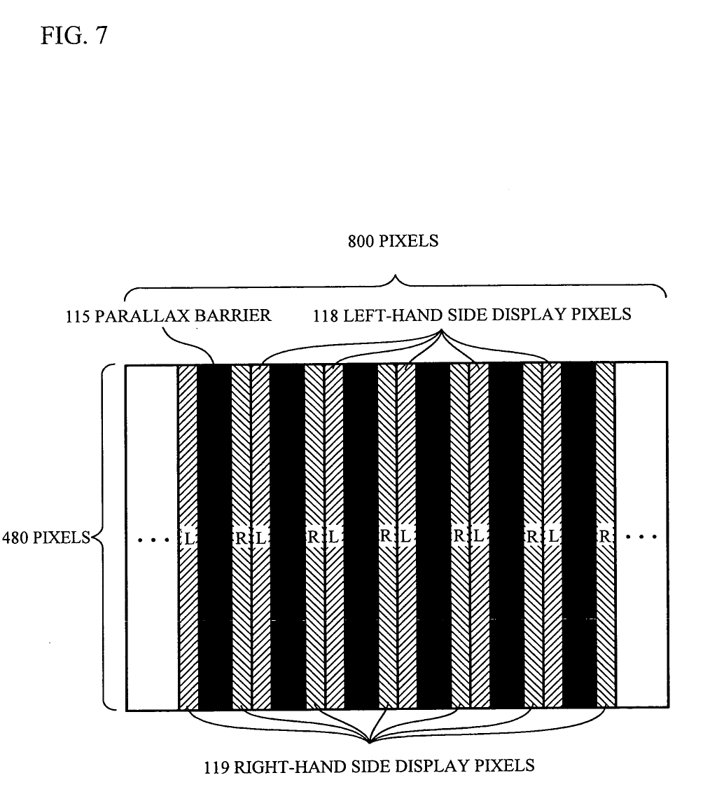

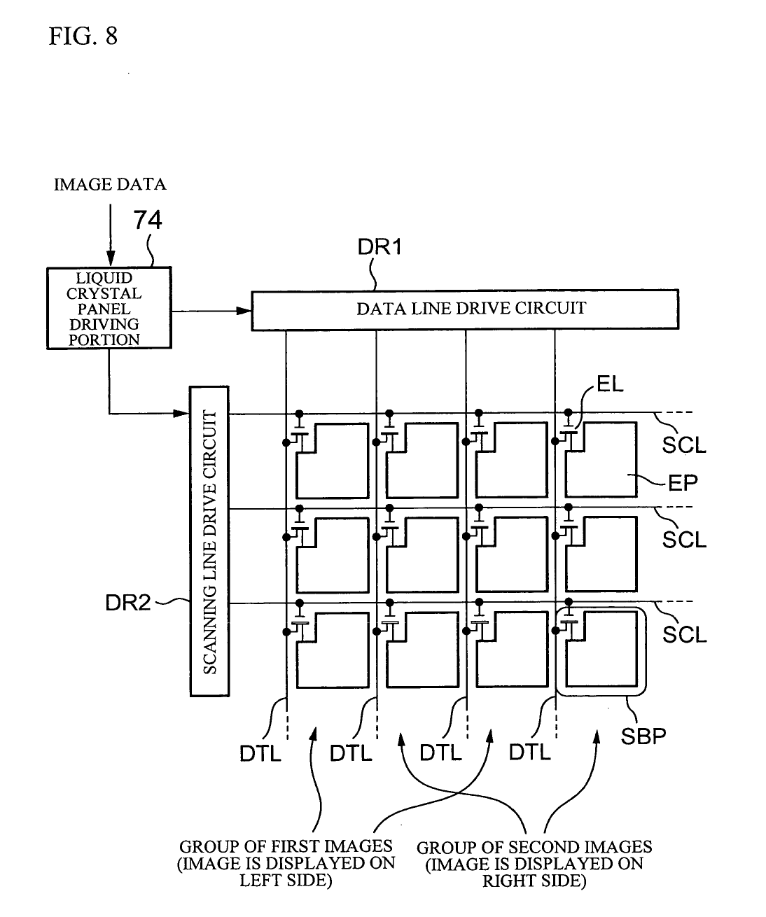

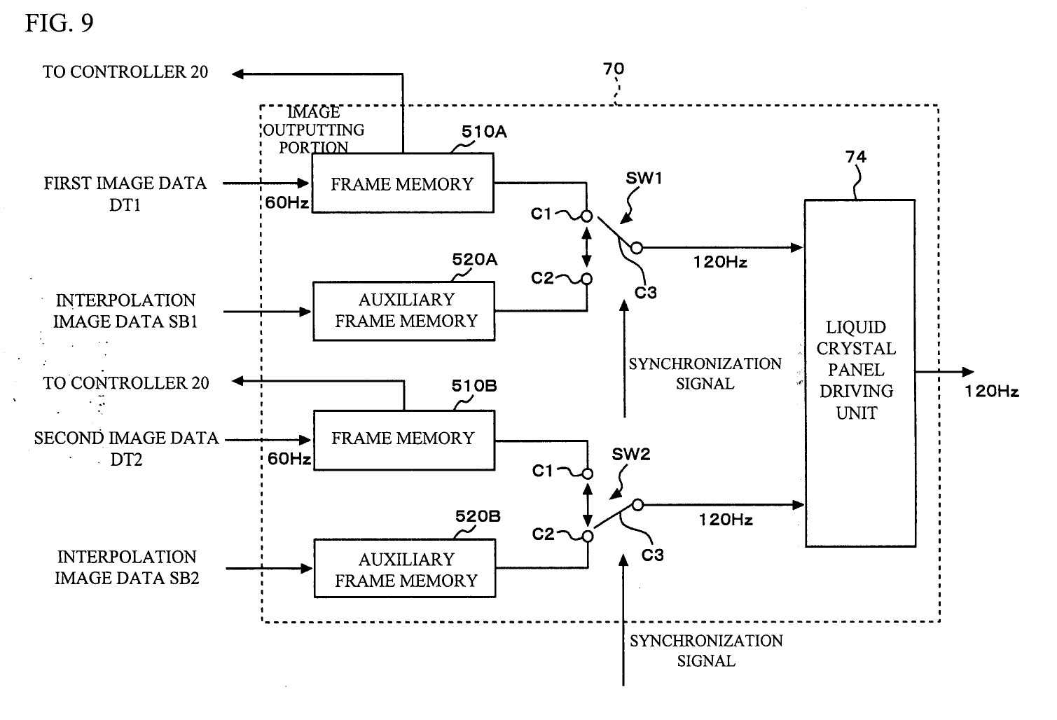

FIG. 3 through FIG. 9 illustrate specific configurations of the display apparatus in accordance with the exemplary embodiment of the present invention. FIG. 3 is a functional block diagram of the display controller 10 and the display 100. FIG. 4 is a functional block diagram showing a configuration of the controller illustrated in FIG. 3. FIG. 5 is a functional block diagram of first and second image quality adjusting circuits illustrated in FIG. 3. FIG. 6 is a view illustrating a cross-sectional configuration and effects of a liquid crystal panel. FIG. 7 is a front view of the liquid crystal panel illustrated in FIG. 3. FIG. 8 is a circuit diagram of a TFT substrate. FIG. 9 is a view showing a configuration of an image outputting portion 70 illustrated in FIG. 3.

As illustrated in FIG. 3, the display controller 10 includes a controller 20, a distribution circuit 30, a first image quality adjusting circuit 50A, a second image quality adjusting circuit 50B, the image outputting portion 70, and the like.

Referring now to FIG. 4, the controller 20 includes a CPU 21, an interface 22, a ROM 23 serving as a program storing portion, a RAM 24 serving as a data storing portion, and the like. The controller 20 controls the multi-view display apparatus according to a program stored in the ROM 23 in a comprehensive manner. The specific control by the controller 20 will also be described later in detail.

The controller 20 is connected to a camera 310, a CD/MD (compact disc/mini disc) reproducing portion 320, a radio receiver 330, a TV receiver 340, a DVD (digital versatile disc) reproducing portion 350, a HD (hard disc) reproducing portion 360, a navigation portion 370, and the like, which are mounted on a vehicle and respectively serve as supply sources supplying images and sounds, as illustrated in FIG. 3. The controller 20 sends and receives data and controls the afore-described components.

The camera 310 captures images of surroundings and the like of the vehicle. The CD/MD reproducing portion 320 reproduces music or images. The radio receiver 330 receives radio waves via an antenna. The TV receiver 340 receives TV waves via an antenna through a selector 341. The DVD reproducing portion 350 reproduces music information and images in a DVD. The HD reproducing portion 360 reproduces images and music information stored in a HD. The navigation portion 370 outputs maps or route guide images on the basis of road information received by a VICS (Vehicle Information and Communication System) information receiver 371 and geographic information received by a GPS (Global Positioning System) information receiver 372.

Additionally, the controller 20 is also connected to a memory 140, the operating portion 150, a remote control send and receive portion 170, a brightness detecting sensor 190, a passenger detecting sensor 200, and the like. The controller 20 enables various controls on the basis of various kinds of data obtained from the afore-mentioned components.

The memory 140 stores various kinds of data. The operating portion 150 is provided for operating the display apparatus. The remote control send and receive portion 170 sends and receives infrared signals or wireless signals between a remote controller 171 provided for controlling the display apparatus remotely. The brightness detecting sensor 190 is composed of a light switch or a light sensor to detect the brightness inside the vehicle. The passenger detecting sensor 200 is composed of a pressure-sensitive sensor or the like on the driver's seat or the front passenger's seat to detect a passenger in the vehicle.

The distribution circuit 30 distributes sound data and image data supplied from the above-described camera 310, the CD/MD reproducing portion 320, the radio receiver 330, the TV receiver 340, the DVD reproducing portion 350, the HD reproducing portion 360, the navigation portion 370, and the like, to the first image quality adjusting circuit 50A or the second image quality adjusting circuit 50B, according to a control instruction issued by the controller 20.

A sound adjusting circuit 60 adjusts the sound data supplied from the distribution circuit 30 to output to a speaker 61.

Each of the first image quality adjusting circuit 50A and the second image quality adjusting circuit 50B, by reference to FIG. 5, includes a contrast adjusting portion 51, a luminance adjusting portion 52, a color tone adjusting portion 53, a gamma value adjusting portion 54, and the like. Each of the first image quality adjusting circuit 50A and the second image quality adjusting circuit 50B respectively adjusts the image qualities (contrast, luimnance, color tone, and gamma value) of the image qualities of the first image data and the second image data (image signal), in response to the control instruction issued by the controller 20.

The display 100 includes the liquid crystal panel 110, a backlight 120, a touch panel 130, and the like, as illustrated in FIG. 3. The backlight 120 sheds illuminated lights from the backside of the liquid crystal panel 110. The touch panel 130 is provided for inputting a signal to operate the multi-view display apparatus. Here, the touch panel 130 is not shown, yet is formed in a shape of transparent sheet and adhered to the front surface of the liquid crystal panel 110.

Referring now to FIG. 6, the liquid crystal panel 110 has a known structure. Sequentially from the backlight 120, there are provided a first deflecting plate 111, a thin film transistor (TFT) substrate 112, a liquid crystal layer 113, a color filter substrate 114 having pixels for three primary colors of RGB, a parallax barrier 115, a glass plate 116, a second deflecting plate 117, and the like.

The above-described liquid crystal panel 110 has a display screen in which, for example, 800 pixels are arranged in a horizontal direction and 480 pixels in a vertical direction, as illustrated in FIG. 7 and FIG. 8. Also, left-hand side display pixels 118 and right-hand side display pixels 119 are alternately arranged in a horizontal direction of the display screen.

The parallax barrier 115 is formed in a stripe-shaped manner, and includes shielding portions and transmitting portions, as illustrated in FIG. 7 and FIG. 8. The shielding portions are arranged between the left-hand side display pixels 118 and the right-hand side display pixels 119 that are adjacent to each other. By providing the parallax barrier 115 on the front surface of the color filter substrate 114, only the lights going towards the left side selectively pass through the transmitting portions of the parallax barrier 115 among the illuminated lights that have passed through the left-hand side display pixels 118. Also, only the lights going towards the right side selectively pass through the transmitting portions of the parallax barrier 115 among the illuminated lights that have passed through the right-hand side display pixels 119. As illustrated in FIG. 6, this makes the first image data IM1 visible from the right side (the driver's seat) of the liquid crystal panel 110, and also makes the second image data IM2 visible from the left side (the front passenger's side).

Here, a similar parallax barrier as disclosed in Japanese Patent Application Publication No. 10-123461 or Japanese Patent Application Publication No. 11-84131 may be employed for the parallax barrier 115.

The TFT substrate 112, by reference to FIG. 8, includes a data line drive circuit DR1, a scanning line drive circuit DR2, vertically arranged scanning lines SCL, horizontally arranged data lines DTL, TFT elements EL, pixel electrodes EP corresponding to the TFT elements EL, and the like, whereas each of the TFT elements EL is formed in each region where each of the scanning lines SCL and each of the data lines DTL are crossed. Sub pixels SBP are formed by regions surrounded by the scanning lines SCL and the data lines DTL. Also, the sub pixels SBP arranged along each of the data lines DTL are alternately assigned to the left-hand side display pixels 118 and the right-hand side display pixels 119.

A drive timing of the data line drive circuit DR1 is controlled by a liquid crystal panel driving unit 74, as will be described later, to control a voltage applied to the pixel electrode EP.

A drive timing of the scanning line drive circuit DR2 is controlled by the liquid crystal panel driving unit 74, as will be described later, to selectively scan the TFT element EL.

The memory 140 may be formed with an electrically rewritable nonvolatile memory such as a flash memory or a volatile memory backed up with batteries, for example. The memory 140 stores necessary data for control operations to be performed by the controller 20, and the like.

As illustrated in FIG. 9, the image output unit 70 includes frame memories 510A and 510B, auxiliary frame memories 520A and 520B, a liquid crystal panel driving unit 74, switches SW1 and SW2, and the like.

The first and second image data (image signals) DT1 and DT2 having the image quality adjusted by the first and second image quality adjusting circuits 50A and 50B are written in the frame memories 510A and 510B, respectively. The first and second image data DT1 and DT2 are image signals (video signals) from the TV reception unit 340, the DVD reproduction unit 350, the navigation unit 370, or the like.

The interpolation image data SB1 and SB2 are written in the auxiliary frame memories 510A and 510B by the controller 20.

The interpolation image data SB1 and SB2 are provided for displaying a black image on the display 100, as will be described later.

The switch SW1 selectively connects a movable contact point C3 to fixed contact points C1 and C2, in response to the synchronization signal SC outputted from the controller 20. When the fixed contact point C1 is connected to the movable contact point C3, the image data DT1 held in the frame memory 510A is output to the liquid crystal panel driving unit 74. When the fixed contact point C2 is connected to the movable contact point C3, the interpolation image data SB1 held n the auxiliary frame memory 520A is output to the liquid crystal panel driving unit 74.

The switch SW2 selectively connects the movable contact point C3 to the contact points C1 and C2, in response to the synchronization signal SC outputted from the controller 20. When the fixed contact point C1 is connected to the movable contact point C3, the image data DT2 held in the frame memory 510B is output to the liquid crystal panel driving unit 74.

When the fixed contact point C2 is connected to the movable contact point C3, the interpolation image data SB2 held n the auxiliary frame memory 520B is output to the liquid crystal panel driving unit 74.

The liquid crystal panel driving unit 74 drives the liquid crystal panel 110 of the display 100. The liquid crystal panel driving unit 74 drives the pixels of the liquid crystal panel 110 so as to display the images for the driver's seat (D seat) side, based on the image data held in the frame memory 510A or the interpolation image data held in the auxiliary frame memory 520A. Also, the liquid crystal panel driving unit 74 drives the pixels of the liquid crystal panel 110 so as to display the images for the front passenger's seat (P seat) side, based on the image data held in the frame memory 510B or the interpolation image data held in the auxiliary frame memory 520B. Additionally, a sorting process for sorting data to correspond to each pixel of the liquid crystal panel 110 is performed by the liquid crystal panel driving unit 74.

Next, a description will be given of a circuit configuration that compares the luminance of the first image data DT1 with that of the second image data DT2 in units of pixels.

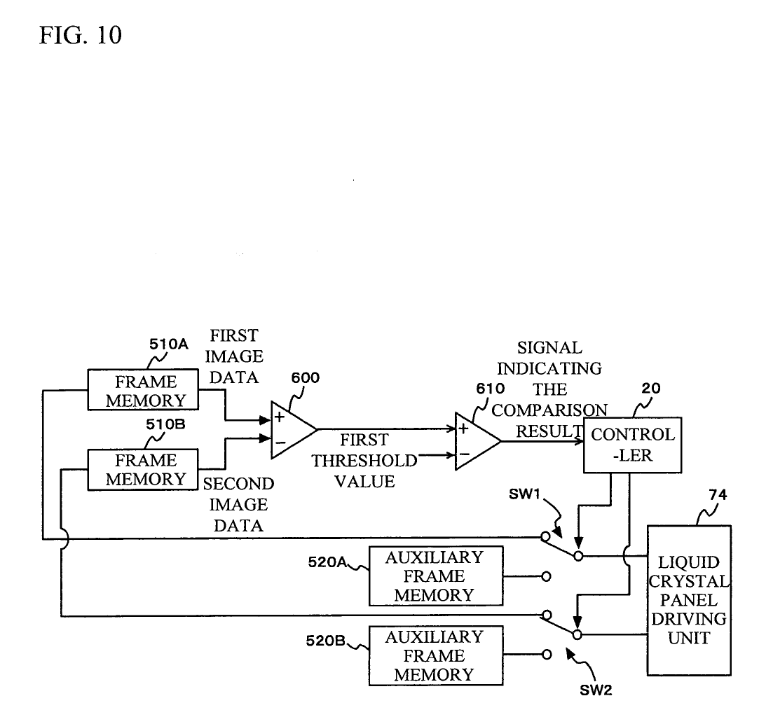

The circuit configuration illustrated in FIG. 10 includes a differential circuit 600, and a comparison circuit (which corresponds to comparison means according to the present invention) 610, and compares the luminance of the first image data DT1 with that of the second image data DT2 in units of pixels. The comparison circuit 610 is outputted to the controller 20. The controller (which corresponds to an interpolation unit according to the present invention) 20 switches between the switches SW1 and SW2, in response to a comparison result of the comparison circuit 610.

The differential circuit 600 calculates a difference between the luminance of the first image data DT1 and that of the second image data DT2. The first image data DT1 and the second image data DT2 are inputted to the differential circuit 600, and then the differential circuit 600 determines the difference in luminance between the image data DT1 and the image data DT2 on a pixel basis.

The differential circuit 600 creates each luminance value Y of the first image data DT1 and that of the second image data DT2 for every pixel, and then determines the difference of the luminance values Y. The luminance value of NTSC (National Television Standards Committee) is determined on the basis of the RGB (red, green, blue) signal by a following formula (1).

Y=0.29′R+0.6′G+0.11′B (1)

The comparison circuit 610 compares the differential value calculated by the differential circuit 600 with the first threshold value, and then outputs a signal that indicates a comparison result to the controller 20. The first threshold value is used as a threshold value for detecting that the attention pixel of the first image data DT1 and that of the second image data DT2 have a small difference in luminance. When the difference in luminance between the attention pixel of the first image data DT1 and that of the second image data DT2 is equal to or smaller than the first threshold value, the comparison circuit 610 outputs to the controller 20 a signal (hereinafter referred to as signal of no difference in luminance), indicating that the difference in luminance between both pixels is equal to or smaller than the first threshold value. In addition, when the difference in luminance between the attention pixel of the first image data DT1 and that of the second image data DT2 is greater than the first threshold value, the comparison circuit 610 outputs a signal (hereinafter referred to as signal of any difference in luminance), indicating that the difference in luminance between both pixels is greater than the first threshold value.

When the signal of no difference in luminance is outputted from the comparison circuit 610 to the controller 20, the controller 20 controls the switches SW1 and SW2 illustrated in FIGS. 9 and 10, and causes the first image data DT1 and the second image data DT2 respectively stored in the frame memories 510A and 510B to be outputted to the liquid crystal panel driving unit 74.

Additionally, when the signal of any difference in luminance is outputted from the comparison circuit 610 to the controller 20, the controller 20 connects the fixed contact point C1 of the switch SW1 to the movable contact point C3, and also connects the fixed contact point C2 of the switch SW2 to the movable contact point C3. That is, the pixel value of the attention pixel read from the frame memory 510A is outputted to the attention pixel of the first image data DT1, and the pixel value of the interpolation pixel read from the auxiliary frame memory 520B is interpolated to the attention pixel of the second image data DT2. Further, the controller 20 connects the fixed contact point C2 of the switch SW1 to the movable contact point C3, and also connects the fixed contact point C1 of the switch SW2 to the movable contact point C3. That is, the pixel value of the attention pixel read from the frame memory 510B is outputted to the attention pixel of the second image data DT2, and the pixel value of the interpolation pixel read from the auxiliary frame memory 520A is interpolated to the attention pixel of the first image data DT1.

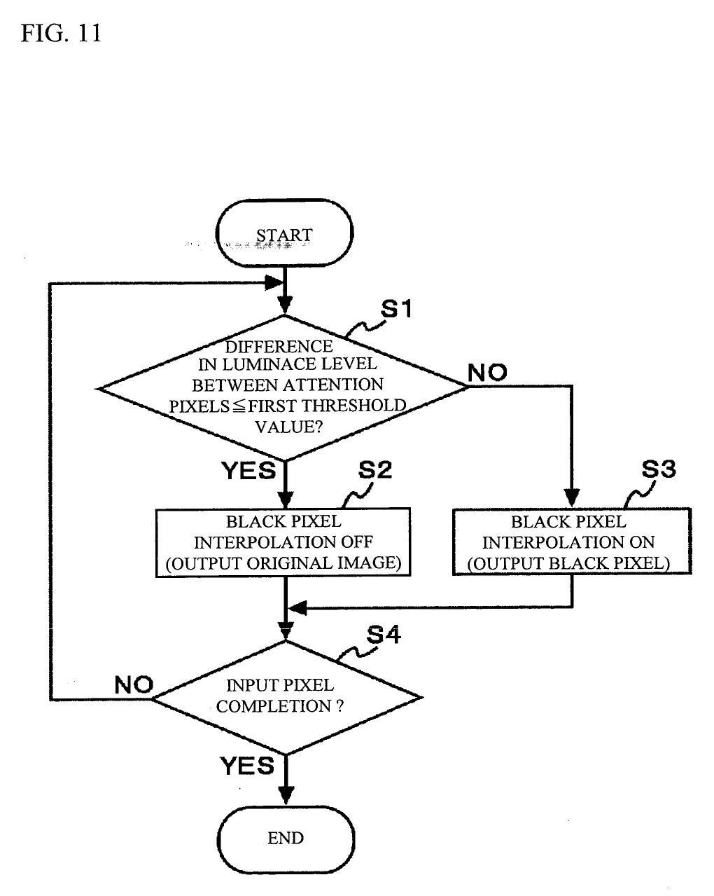

A description will be given of a process sequence of the controller 20 with reference to a flowchart as illustrated in FIG. 11. In addition, the interpolation pixel to be interpolated will be described as a black pixel in this flow chart.

When the signal of no difference in luminance is inputted to the controller 20, the controller 20 determines that the difference in luminance between the attention pixel of the first image data DT1 and that of the second image data DT2 is equal to or smaller than the first threshold value (step S1/YES).

In this case, the controller 20 switches between the switches SW1 and SW2 to turn off the interpolation of the black pixel (step S2). Since the difference in luminance between the first image data DT1 and the second image data DT2 is small, the black pixel is not interpolated, and then the pixel values of the first image data DT1 and the second image data DT2 are outputted without being changed. Also, the signal of any difference in luminance is inputted from the comparison circuit 610 to the controller 20, the controller 20 determines that the difference in luminance between the attention pixels of the first image data DT1 and the second image data DT2 is greater than the first threshold value (step S1/No). In this case, the controller 20 alternately switches between the switches SW1 and SW2 to alternately interpolate the black pixel to the first image data DT1 and the second image data DT2. The above mentioned processes are applied to all of the input pixels (step S4).

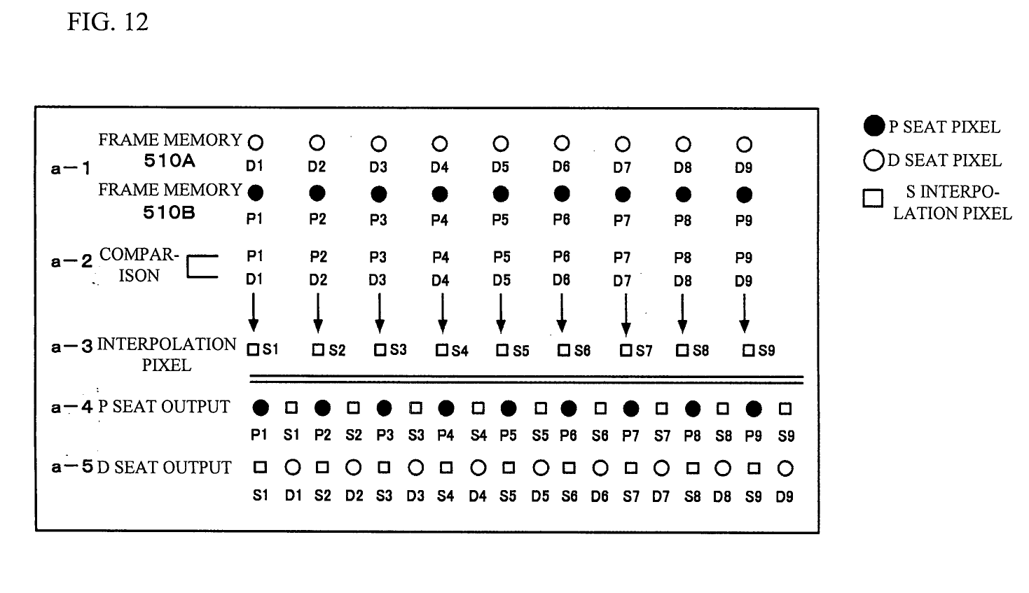

Here, a description will be given of the processes of the differential circuit 600 and the comparison circuit 610 in detail with reference to FIG. 12. In addition, in the following description, the first image data DT1 will be described as a driver's side image D that is visible from the driver's seat side, and the second image data DT2 will be described as a passenger's seat side image P that is visible from the passenger's seat side.

At (a-1) illustrated in FIG. 12, the first image data DT1 stored in the frame memory 510A and the second image data DT2 stored in the frame memory 510B are arranged in units of pixel. The pixels D1, D2, D3, D4, . . . , are read from the frame memory 510A in this order, as illustrated at (a-1) in FIG. 12, and are then outputted to the differential circuit 600. Likewise, the pixels P1, P2, P3, P4, . . . , are read from the frame memory 510B in this order, as illustrated at (a-1) in FIG. 12, and are then outputted to the differential circuit 600.

The differential circuit 600 determines the difference in luminance between the pixel read from the frame memory 510A and the pixel read from the frame memory 510B. For example, when an attention is paid to D3 and P3 illustrated in FIG. 12, the differential circuit 600 determines (D3-P3) as a differential value in luminance, and then outputs it to the comparison circuit 610. The comparison circuit 610 compares (D3-P3) with the first threshold value. When the difference in luminance is equal to or smaller than the first threshold value, the comparison circuit 610 outputs the signal of no difference in luminance, indicating that the difference in luminance is equal to or smaller than the first threshold value, to the controller 20. Additionally, when the difference in luminance is greater than the first threshold value, the comparison circuit 610 outputs to the controller 20 the signal of any difference in luminance, indicating that the difference in luminance is greater than the first threshold value.

When the signal of no difference in luminance is inputted from the comparison circuit 610 to the controller 20, the controller 20 controls the switches SW1 and SW2 to alternately interpolate the interpolation pixel stored in the auxiliary frame memory 520A to the driver's side image D and interpolate the interpolation pixel stored in the auxiliary frame memory 520B to the front passenger's seat side image P. In the example illustrated in FIG. 12, the pixel S3 is read, as the interpolation pixel of the driver's side image D3 and the front passenger's seat side image P3, from the auxiliary frame memories 520A and 520B. A series of pixels to be outputted as the front passenger's seat side image P is illustrated at a-4 in FIG. 12. A series of pixels to be outputted as the drive side image D is illustrated at a-5 in FIG. 12. As illustrated in FIG. 12, the controller 20 switches the connections of the switches SW1 and SW2 to alternately output the interpolation pixel S3 to the driver's side image D and the front passenger's seat side image P.

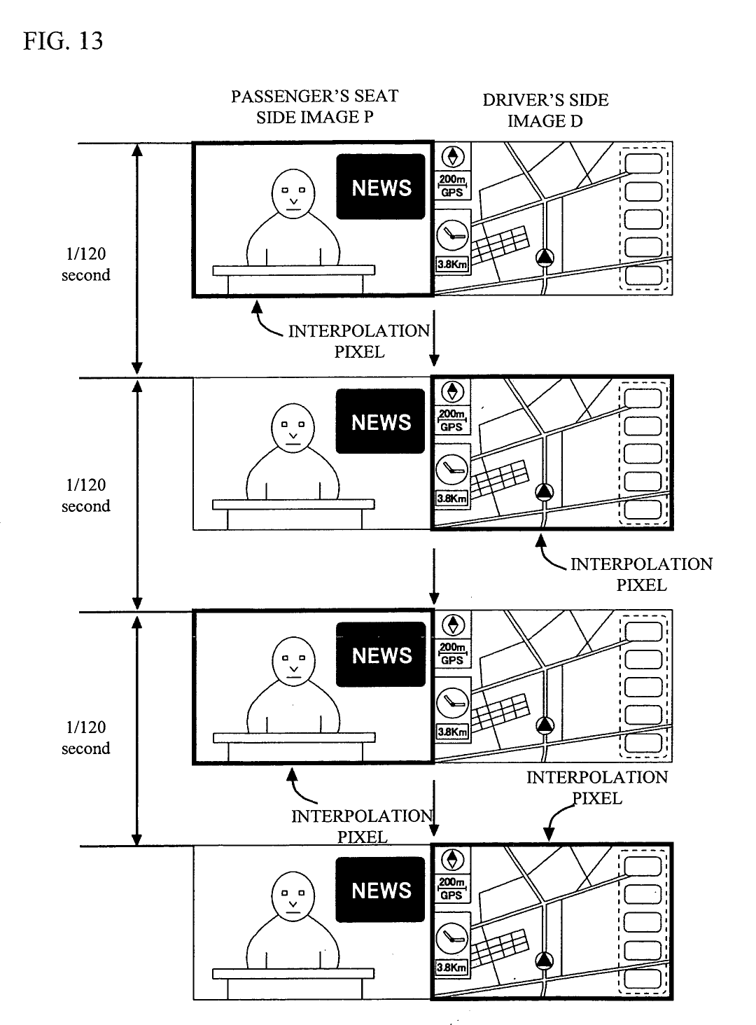

FIG. 13 shows an example of the image displayed on the display 100 by the above-mentioned processes. In the example shown in FIG. 13, to reduce the large difference in luminance between the edge areas of the first image data DT1 and the second image data DT2, the interpolation pixel is interpolated alternately in the edge areas of the first image data DT1 and the second image data DT2.

In the above-mentioned present embodiment, the luminance of the first image data DT1 is compared with that of the second image data DT2 in units of pixels, and the pixel having reduced luminance is interpolated at the time when the difference in luminance is equal to or greater than the first threshold value, thereby reducing the luminance. This reduces the crosstalk of the images and improves the visibility of the images.

### [First Variation]

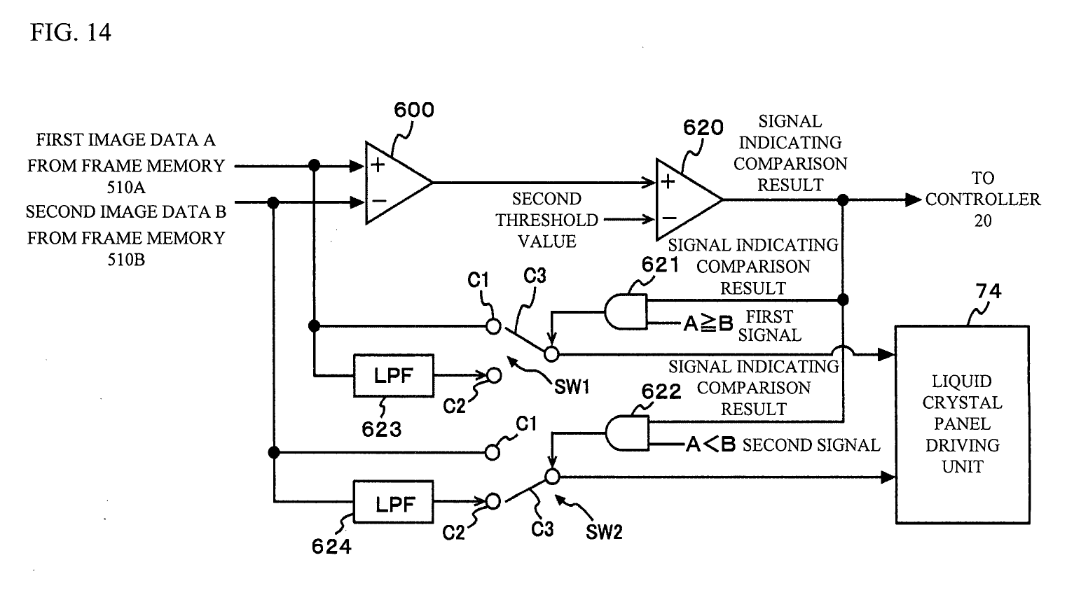

A circuit, which compares the luminance of the first image data DT1 with that of the second image data DT2 in units of pixels and which controls the image data to be outputted to the liquid crystal panel driving unit 74, may have a configuration illustrated in FIG. 14.

The circuit configuration illustrated in FIG. 14 includes AND gates (corresponding to interpolation means according to the present invention) 621 and 622, and low-pass filters (hereinafter referred to as LPFs) 623 and 624, instead of the auxiliary frame memories 520A and 520B illustrated in FIG. 9. In addition, a threshold value, which is inputted to a comparison circuit (corresponding to comparison means according to the present invention) 620, is modified to a second threshold value from the first threshold vale.

The second threshold value, which is inputted to the comparison circuit 620, is provided for detecting that there is a large difference in luminance between the first image data DT1 and the second image data DT2. When the difference in luminance between the attention pixel of the first image data DT1 and that of the second image data DT2 is greater than the second threshold value, the comparison circuit 620 outputs to the controller 20 the signal of any difference in luminance, indicating that there is a large difference in luminance of the attention pixels. This signal of any difference in luminance is also outputted to the AND gates 621 and 622 illustrated in FIG. 14. Additionally, when the difference in luminance between the attention pixel of the first image data DT1 and that of the second image data DT2 is equal to or smaller than the second threshold value, the comparison circuit 620 outputs to the controller 20 the signal of no difference in luminance, indicating that there is a small difference in luminance of the attention pixels.

The AND gate 621 is supplied with a signal (signal of no difference in luminance or signal of any difference in luminance), which indicates the comparison result, from the comparison circuit 620, and a signal (hereinafter referred to as first signal), which indicates that the luminance of the attention pixel of the first image data DT1 is equal to or greater than that of the attention pixel of the second image data DT2. The first signal is outputted from the controller 20 to the AND gate 621. When the signal of any difference in luminance is inputted to the AND gate 621 from the comparison circuit 620 and the first signal is inputted to the AND gate 621 from the controller 20, the AND gate 621 switches the switch SW1 to output the signal from the LPF 623 to the liquid crystal panel driving unit 74.

The luminance of the first image data DT1 passing through the LPF 623 is a lowered signal.

Also, the signal (signal of no difference in luminance or signal of any difference in luminance), which indicates the comparison result, is inputted to the AND gate 622 from the comparison circuit 620. A signal (hereinafter referred to as second signal), which indicates that the luminance of the attention pixel of the first image data DT1 is smaller than that of the attention pixel of the second image data DT2, is inputted to the comparison circuit 620. The second signal is outputted from the controller 20 to the AND gate 622. When the signal of any difference in luminance is inputted to the AND gate 622 from the comparison circuit 620 and the second signal is inputted to the AND gate 622 from the controller 20, the AND gate 622 switches the switch SW2 to output the signal from the LPF 624 to the liquid crystal panel driving unit 74.

The luminance of the second image data DT2 passing through the LPF 623 is also a lowered signal.

When the output of the LPF 623 or 624 is selected, the liquid crystal panel driving unit 74 alternately inserts the output from the LPF 623 to the first image data DT1 and inserts the output from the LPF 624 to the second image data DT2, the first image data DT1 and the second image data DT2 being outputted to the liquid crystal panel driving unit 74.

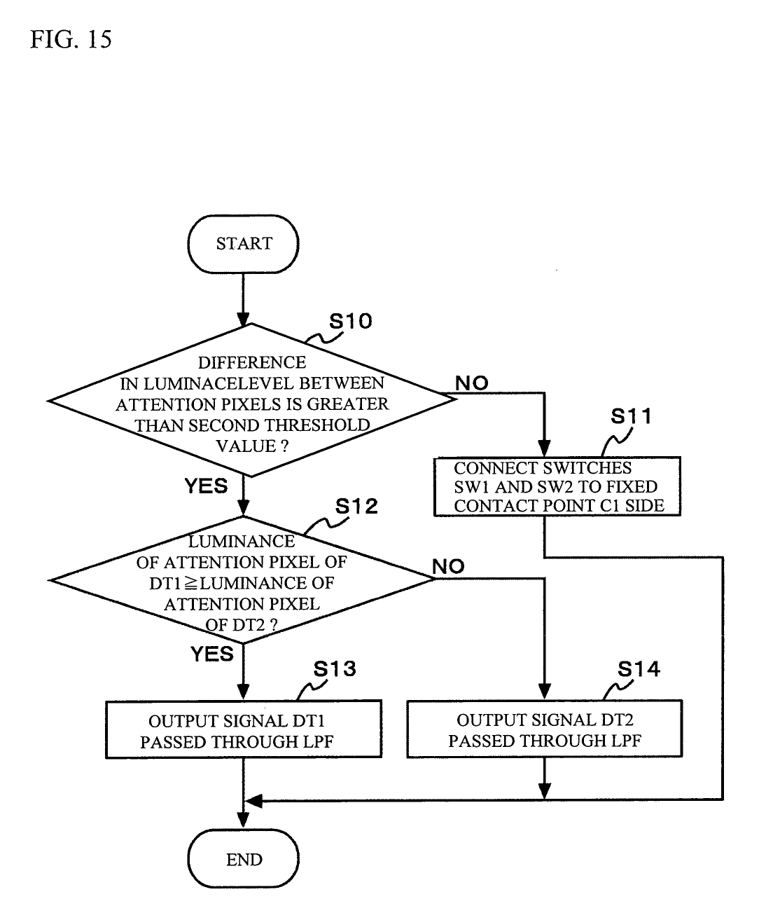

A description will be given of a process sequence the circuit illustrated in FIG. 14 with reference to a flowchart illustrated in FIG. 15.

When the difference in luminance between the attention pixel of the first image data DT1 and that of the second image data DT2 is greater than the second threshold value (step S10/YES), the comparison circuit 620 outputs the signal of any difference in luminance, indicating that the difference in luminance is greater than the second threshold value, to the controller 20, and to the AND gates 621 and 622.

When the luminance of the attention pixel of the first image data DT1 is equal to or greater than that of the attention pixel of the second image data DT2 (step S12/YES), the first signal is outputted to the AND gate 621 by the controller 20. When the first signal and the signal of any difference in luminance are inputted to the AND gate 621, the AND gate 621 outputs a high-level signal for switching the switch SW1. By the output signal from the AND gate 621, the switch SW1 is switched, so the output of the LPF 623 is selected (step S13). The output of the LPF 623 is inputted to the liquid crystal panel driving unit 74.

When the luminance of the attention pixel of the first image data DT1 is smaller than that of the attention pixel of the second image data DT2 (step S12/NO), the second signal is outputted to the AND gate 622 from the controller 20. When the second signal and the signal of any difference in luminance are inputted to the AND gate 622, the AND gate 622 outputs a high-level signal for switching the switch SW2. By the output signal from the AND gate 622, the switch SW2 is switched, so the output of the LPF 624 is selected (step S14). The output of the LPF 624 is inputted to the liquid crystal panel driving unit 74.

When the signal having a small luminance and passing through the LPF 623 or LPF 624 is inputted to the liquid crystal panel driving unit 74, the liquid crystal panel driving unit 74 switches its output to alternately insert the signal to the first image data DT1 and the second image data DT2.

Also, when the difference in luminance between the attention pixel of the first image data DT1 and that of the second image data DT2 is equal to or smaller than the second threshold value (step S10/NO), the comparison circuit 620 outputs the signal of no difference in luminance to the controller 20. By outputting the signal of no difference in luminance to the AND gates 621 and 622, the outputs of the AND gates 621 and 622 are switched to low levels. Thus, the switches SW1 and SW2 are connected to the fixed contact point C1 side (step S11), so that the attention pixel of the first image data DT1 and that of the second image data DT2 are directly outputted to the liquid crystal panel driving unit 74.

### [Second Variation]

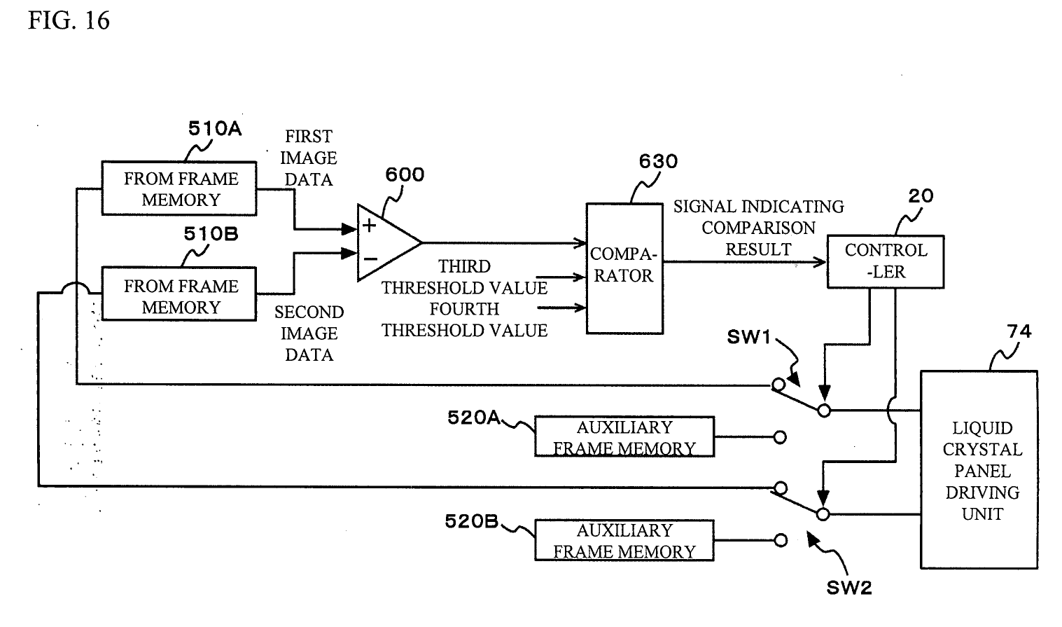

A circuit configuration, which compares the luminance of the first image data DT1 with that of the second image data DT2 in units of pixels and which controls the image data to be outputted to the liquid crystal panel driving unit 74, may have a configuration illustrated in FIG. 16.

The circuit configuration illustrated in FIG. 16 includes a comparator (corresponding to an interpolation unit according to the present invention) 630, instead of the comparison circuit 610 illustrated in FIG. 10. A third threshold value and a fourth threshold value are inputted to the comparator 630, in addition to the differential value of the luminance calculated by the differential circuit 600. The forth threshold value is set to be greater than the third threshold value (third threshold value<forth threshold value). In addition, the forth threshold value corresponds to a second threshold value recited in claims, and the third threshold value corresponds to a third threshold value recited in claims.

When the differential value calculated by the differential circuit 600 is equal to or greater than the third threshold value and is smaller than the forth threshold value, the comparator 630 outputs a signal (hereinafter referred to as third signal), indicating that the difference in luminance is equal to or greater than the third threshold value and is smaller than the forth threshold value, to the controller 20.

When the third signal is inputted from the comparator 630 to the controller (corresponding to an interpolation unit according to the present invention) 20, the controller 20 reduces the luminance of the corresponding pixel on the basis of this signal.

When the differential value calculated by the differential circuit 600 is smaller than the third threshold value, the comparator 630 outputs a signal (hereinafter referred to as fourth signal), indicating that the difference in luminance is smaller than the third threshold value, to the controller 20. When the fourth signal is inputted from the comparator 630 to the controller 20, the controller 20 determines that there is no difference in luminance between the attention pixel of the first image data DT1 and that of the second image data DT2, and then prohibits the interpolation of a black pixel.

When the differential value calculated by the differential circuit 600 is greater than the fourth threshold value, the comparator 630 outputs a signal (hereinafter referred to as fifth signal), indicating that the difference in luminance is greater than the fourth threshold value, to the controller 20. When the fifth signal is inputted to the comparator 630, the controller 20 determines that the difference in luminance between the attention pixel of the first image data DT1 and that of the second image data DT2, and then outputs a signal for permitting the black pixel to be interpolated. Additionally, the third threshold value may be set to be identical with the first threshold value. Likewise, the fourth threshold value may be set to be identical with the second threshold value.

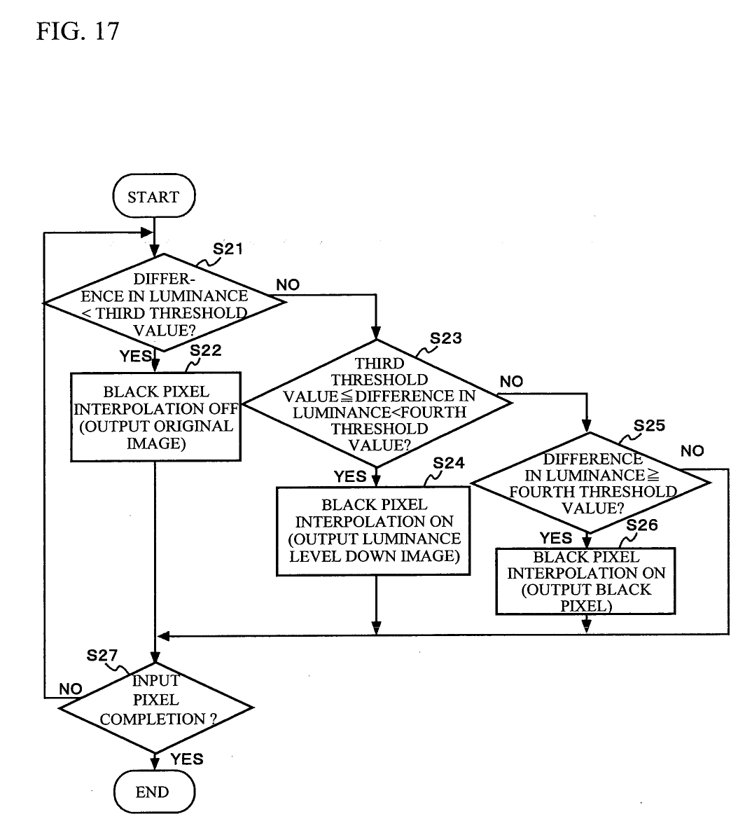

A description will be given of a process sequence of the controller 20 with reference to a flowchart illustrated in FIG. 17.

When the fourth signal, which indicates that the difference in luminance is smaller than the third threshold, is inputted from the comparator 630 to the controller 20 (step S21/YES), the controller 20 determines that the difference in luminance between the attention pixel of the first image data DT1 and that of the second image data DT2, and then set to turn off the interpolation of the black pixel (step S22).

When the third signal, which indicates that the differential value in luminance is equal to or greater than the third threshold value and is smaller than the forth threshold value, is inputted from the comparator 630 to the controller 20 (step S23/YES), the controller 20 reduces the luminance of the corresponding pixel on the basis of this signal (step S24).

When the fifth signal, which indicates that the differential value in luminance is equal to or greater than the forth threshold value, is inputted from the comparator 630 to the controller 20 (step S25/YES), the controller 20 determines that the difference in luminance between the attention pixel of the first image data DT1 and that of the second image data DT2, and then outputs a signal for permitting the black pixel to be interpolated (step S26).

### [Third Variation]

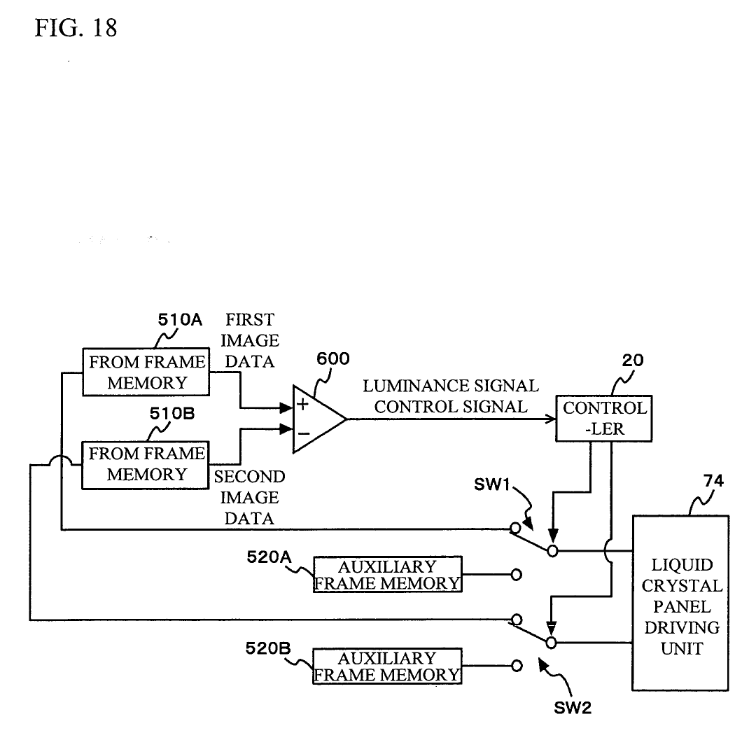

A circuit, which compares the luminance of the first image data DT1 with that of the second image data DT2 in units of pixels and which controls the image data to be outputted to the liquid crystal panel driving unit 74, may have a configuration illustrated in FIG. 18.

The circuit configuration illustrated in FIG. 18 directly outputs the differential value in luminance, which is calculated by the differential circuit 600 illustrated in FIG. 10, to the controller 20.

The controller 20 controls the luminance of the attention pixel in response to the difference in luminance calculated by the differential circuit 600. That is, the luminance of the attention pixel is reduced and a pixel more similar to the black pixel is interpolated, as the difference in luminance between the attention pixel of the first image data DT1 and that of the second image data DT2 is greater. When the difference in luminance between the attention pixel of the first image data DT1 and that of the second image data DT2 is small, the luminance of the attention pixel is not reduced and a pixel more similar to the white pixel is interpolated.

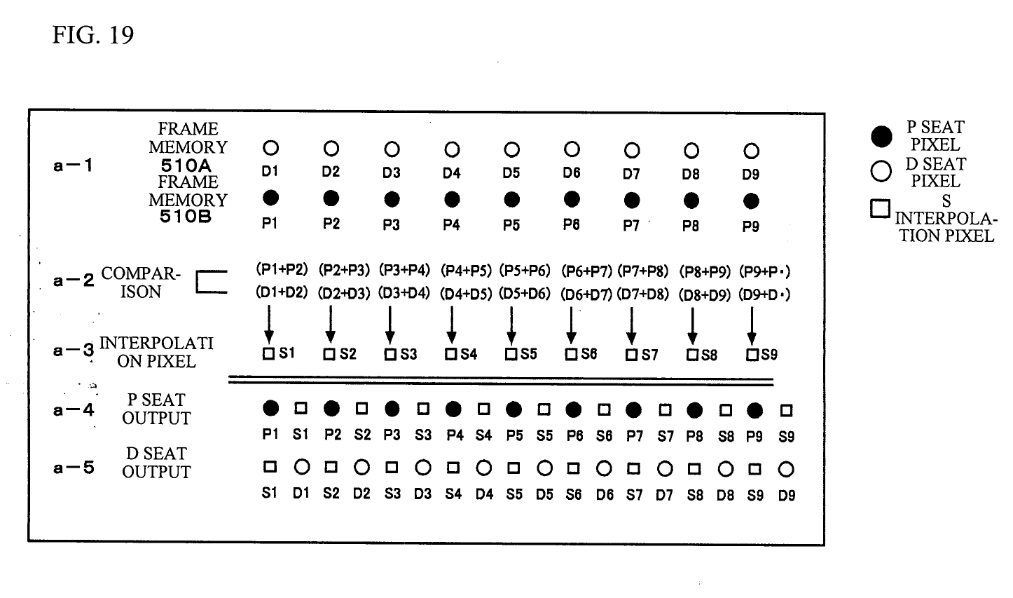

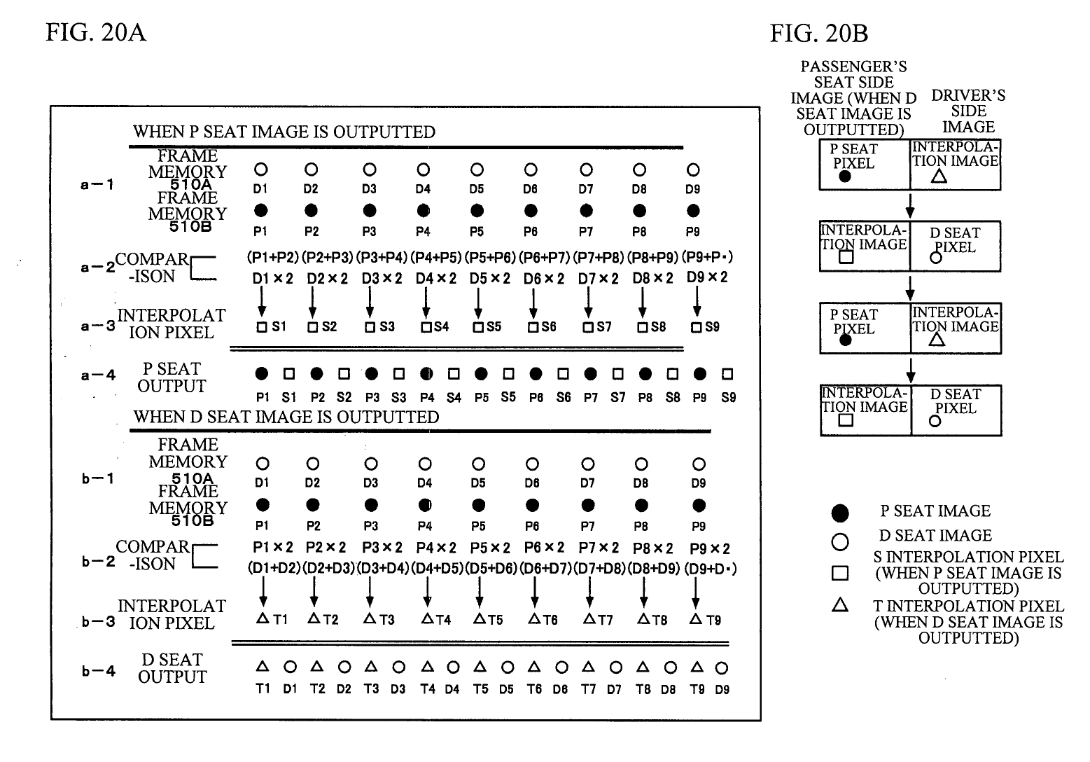

In the above description, the luminance of the attention pixel of the first image data DT1 and that of the attention pixel of the second image data DT2 are directly compared by calculating the difference in luminance between the attention pixels. In addition thereto, the comparison can be performed by methods illustrated in FIGS. 19 and 20. In the method illustrated in FIG. 19, the luminance of the attention pixel is compared with a luminance of an adjacent pixel, in addition to the comparison of the attention pixel of the first image data DT1 and that of the second image data DT2.

A description will be given of a method for comparing the luminance in FIG. 19. First, an adding circuit not illustrated is provided in a former stage of the differential circuit 600, and adds the pixel values of the adjacent pixels of the driver's side image D. That is, (D1+D2), (D2+D3), (D3+D4), . . . , are determined by adding the pixel values of the adjacent pixels of the driver's side images D1, D2, D3, D4, . . . . Likewise, (P1+P2), (P2+P3), (P3+P4), . . . , are determined by adding the pixel values of the adjacent pixels of the front passenger's seat side images P1, D2, P3, P4, . . . .

The differential circuit 600 determines the difference between the driver's side image and the front passenger's seat side image, which are added by the adding circuit. In the example shown in FIG. 19, the difference between (D1+D2) and (P1+P2), the difference between (D2+D3) and (P2+P3), and the like are determined (referring to (a-2) in FIG. 19). The comparison circuit 610 determines whether or not the interpolation pixel is interpolated to the attention pixel, on the basis of the calculated differential value of the luminance. (a-3) in FIG. 19 illustrates the state where the interpolation pixels (S1, S2, S3, S4, . . . ) are selected in response to the comparison result of the comparison circuit 610. Further, (a-4, a-5) illustrates the state where the difference between the driver's side image D and the front passenger's seat side image P is greater than the threshold value is continuously generated, and where the interpolation pixel is alternately interpolated in the driver's side image D and the front passenger's seat side image P.

Also, the driver's side image D and the front passenger's seat side image P may be individually processed. In the example shown in FIGS. 20A and 20B, regarding the process of the front passenger's seat side image P, the additional values (P1+P2), (P2+P3), . . . are determined by adding the adjacent pixels of the front passenger's seat side images P1, P2, P3, . . . as illustrated at (a-2) in FIG. 20A. Pixel values (D1′2), (D2′2), . . . are determined by doubling each of the driver's seat side images D1, D2, D3 . . . . Next, the differential circuit 600 determines the difference between these pixel values. That is, the difference in luminance between (P1+P2) and (D1′2), the difference in luminance between (P2+P3) and (D2′2), and the like are determined as illustrated at (a-2) in FIG. 20A. The comparison circuit 610 determines whether or not the interpolation pixel is interpolated to the attention pixel on the basis of the calculated differential value of the luminance. (a-3) in FIG. 20A illustrates the state where the interpolation pixels (S1, S2, S3, S4, . . . ) are selected in response to the comparison result of the comparison circuit 610. When the interpolation pixel is selected, the interpolation pixel is interpolated in the front passenger's seat side image P as illustrated at (a-4) in FIG. 20A.

Likewise, in the process for the driver's side image D, the additional values (D1+D2), (D2+D3), . . . are determined by adding the adjacent pixels of the driver's side images D1, D2, D3, as illustrated at (b-2) in FIG. 20A. Pixel values (P1′2), (P2′2), . . . are determined by doubling each of the front passenger's seat side images P1, P2, P3 . . . . Then, the differential circuit 600 determines the differences between these pixel values, and the comparison circuit 610 determines whether or not the interpolation pixels (T1, T2, T3, T4 . . . ) are interpolated in the attention pixel.

FIG. 20B shows the example where a supplementary image is displayed as the front passenger seat image at the time of displaying the driver's side image and where the supplementary image is displayed as the driver's side image at the time of displaying the front passenger's seat side image.

Further, there are various methods for calculating the luminance to be compared between the image data, in addition to the above-mentioned embodiments. For example, a difference between an R signal of the first image data DT1 and that of the second image data DT2, a difference between a G signal of the first image data DT1 and that of the second image data DT2, a difference between a B signal of the first image data DT1 and that of the second image data DT2, may be determined on a pixel basis. An average value of these differences may be determined as the difference in luminance between the attention pixels.

Alternately, the highest luminance among the R, G, and B signals of the first image data DT1, and the highest luminance among the R, G, and B signals of the second image data DT2, may be determined. The difference between the both may be determined on a pixel basis.

### Second Embodiment

In the above-mentioned first embodiment, the differential value between the first image data DT1 and the second image data DT2 are determined on a pixel basis, and this differential value is compared with the threshold value.

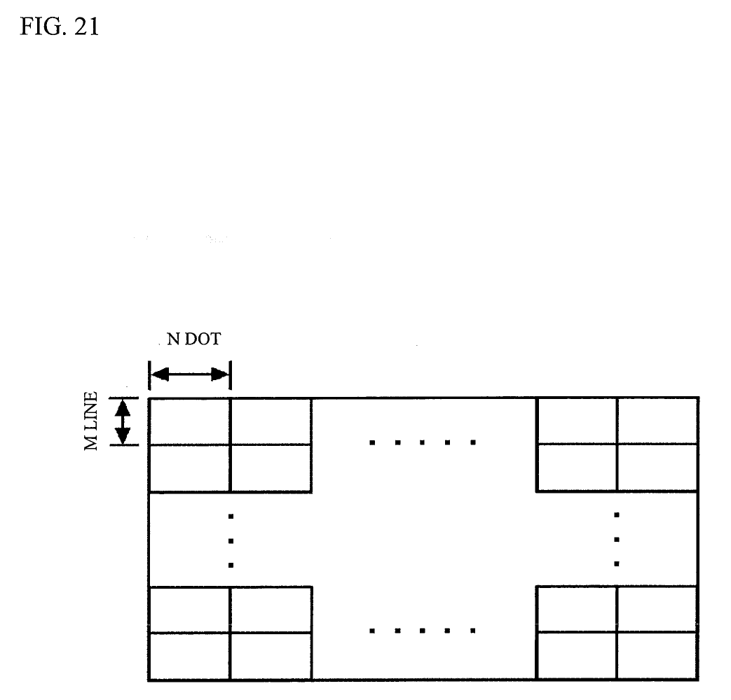

In the present embodiment, the one flame of image data is divided in units of block each being composed of N (dot) ′ M (line) (N and M are any natural numbers), as illustrated in FIG. 21. The luminance values of the first image data DT1 and that of the second image data DT2 are compared in units of the divided block. For example, the difference in luminance between the first image data DT1 and the second image data DT2 is determined in units of pixel, so the average value within one block is determined on the basis of the determined difference in luminance. The interpolation data, which is interpolated to the first image data DT1 and the second image data DT2, is controlled on the basis of this average value.

Also, the pixel having the highest luminance in each of the first image data DT1 and the second image data DT2 within one block may be determined, and then the interpolation data, which is interpolated in the first image data DT1 and the second image data DT2, may be controlled based on the difference in luminance of these pixels.

In this way, in the present embodiment, the first image data DT1 and the second image data DT2 are compensated to reduce the difference in luminance therebetween. This reduces the crosstalk of images and improves the visibility thereof. Moreover, the compensation is performed in units of block, thereby simplifying the process.

### Third Embodiment

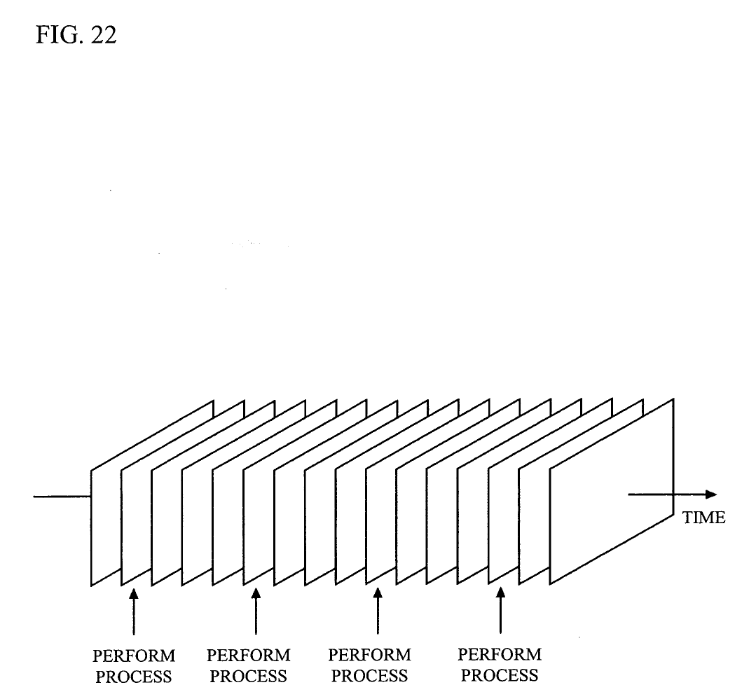

In the first and second embodiments, the interpolation of the interpolation data is controlled in all the frame of the image data. In the present embodiment, the frame to be processed by way of the first or second embodiment is selected, as illustrated in FIG. 22, and then the interpolation date is controlled for every a few frames.

The interpolation of the interpolation data may be controlled in units of pixel, as described in the first embodiment, or in units of block each being composed of N (dot) ′ M (line), as described in the second embodiment. Such control also ensures the same effects of the first and second embodiments.

The present invention is not limited to the above-mentioned embodiment, and other embodiments, variations and modifications may be made without departing from the scope of the present invention.

1. A display control device comprising:
comparison portion that compares a luminance of a first image with a luminance of a second image in units of pixel;
interpolation portion that interpolates a pixel value, having a luminance smaller than an attention pixel of at least one of the first image and the second image, in said at least one of the first image and the second image, when a difference in luminance between an attention pixel of the first image and an attention pixel of the second image is equal to or greater than a first threshold value; and
display control portion that displays the first image and the second image on a common display portion such that the first image and the second image are respectively visible from different viewing directions.

2. The display control device of claim 1, wherein the interpolation portion directly outputs pixel values of attention pixels of the first image data and the second image data to the display control, when the difference in luminance between the attention pixel of the first image and the attention pixel of the second image is smaller than the first threshold value.

3. A display control device comprising:
comparison portion that compares a luminance of a first image with a luminance of a second image on a pixel basis;
interpolation portion that interpolates a black pixel in at least one of the first image and the second image, when a difference in luminance between an attention pixel of the first image and an attention pixel of the second image is equal to or greater than a second threshold value, and that interpolates a pixel value, having a luminance smaller than the attention pixel of at least one of the first image and the second image, in said at least one of the first image and the second image, when the difference in luminance between the attention pixel of the first image and the attention pixel of the second image is equal to or greater than a third threshold value, the third threshold value being smaller than the second threshold value; and
display control portion that displays the first image and the second image on a common display portion such that the first image and the second image are respectively visible from different viewing directions.

4. A display control device comprising:
comparison portion that compares a luminance of a first image with a luminance of a second image in units of pixel;
interpolation portion that interpolates a pixel value that is adjusted based on a difference in luminance between an attention pixel of the first image and an attention pixel of the second image in at least one of the first image and the second image; and
display control portion that displays the first image and the second image on a common display portion such that the first image and the second image are respectively visible from different viewing directions.

5. The display control device of claim 1, wherein the comparison portion compares the luminance of the first image with the luminance of the second image by comparing a luminance of an RGB signal of the first image with a luminance of an RGB signal of the second image.

6. The display control device of claim 1, wherein the interpolation portion interpolates the pixel value having the luminance smaller than the attention pixel in the first image data and the second image data for every given frames.

7. A display control device comprising:
comparison portion that compares a luminance of a first image with a luminance of a second image for every block with a given size;
interpolation portion that interpolates a block of an image, having a luminance smaller than a block to be compared with, of at least one of the first image and the second image, in said at least one of the first image and the second image, when a difference in luminance between a block of the first image and a block of the second image is a first threshold value; and
display control portion that displays the first image and the second image on a common display portion such that the first image and the second image are respectively visible from different viewing directions.

8. The display control device of claim 7, wherein the comparison portion compares the luminance by determining an average value or a maximum value of each luminance of blocks, to be compared with, of the first image and the second image.

9. The display control device of claim 7, wherein the interpolation portion interpolates the block of the image having the luminance having a smaller than the luminance of the block to be compared with for every given frames of each of the first image and the second image.

10. A display device comprising:
a display that displays a first image and a second image on a common display portion such that the first image and the second image are respectively visible from different viewing directions; and
a display control device comprising:
a comparison portion that compares a luminance of a first image with a luminance of a second image in units of pixel;
an interpolation portion that interpolates a pixel value that is adjusted based on a difference in luminance between an attention pixel of the first image and an attention pixel of the second image in at least one of the first image and the second image; and
a display control portion that displays the first image and the second image on a common display portion such that the first image and the second image are respectively visible from different viewing directions.

11. A display control method comprising:
a step that compares a luminance of a first image with a luminance of a second image in units of pixel;
a step that that interpolates a pixel value, having a luminance smaller than an attention pixel of at least one of the first image and the second image, in said at least one of the first image and the second image, when a difference in luminance between an attention pixel of the first image and an attention pixel of the second image is equal to or greater than a first threshold value; and
a step that displays the first image and the second image on a common display portion such that the first image and the second image are respectively visible from different viewing directions.
